(19) United States
(12) Patent Application Publication
(10) Pub. No.: US 2014/0354684 A1
(43) Pub. Date: Dec. 4, 2014

(54) SYMBOLOGY SYSTEM AND AUGMENTED REALITY HEADS UP DISPLAY (HUD) FOR COMMUNICATING SAFETY INFORMATION

(71) Applicants: Lee Beckwith, Palo Alto, CA (US); Victor Ng-Throw-Hing, Sunnyvale, CA (US)

(72) Inventors: Lee Beckwith, Palo Alto, CA (US); Victor Ng-Throw-Hing, Sunnyvale, CA (US)

(73) Assignee: HONDA MOTOR CO., LTD., Tokyo (JP)

(21) Appl. No.: 13/903,406

(22) Filed: May 28, 2013

(51) Int. Cl. G06T 11/60; B60Q 1/00

(52) U.S. Cl. CPC G06T 11/60; B60Q 1/00
USPC 345/633; 340/438

(57) ABSTRACT

An augmented reality driver system, device, and method for providing real-time safety information to a driver by detecting the presence and attributes of pedestrians and other road users in the vicinity of a vehicle. An augmented reality controller spatially overlays an augmented reality display on a volumetric heads up by projecting indicators, associated with the social and behavioral states of road users, in a visual field of the driver.

### BACKGROUND

As a general rule, motor vehicles have a heightened duty to avoid collisions with pedestrians and bicyclists. Drivers should yield the right-of-way to pedestrians crossing streets in marked or unmarked crosswalks in most situations. Drivers should be especially cautious at intersections where the failure to yield the right-of-way often occurs when drivers are turning onto another street and a pedestrian is in their path. Drivers also should be aware of pedestrians in areas where they are less expected (i.e. areas other than intersections and crosswalks) as data from the National Highway Traffic Safety Administration reveals that accidents involving a vehicle and a pedestrian are more likely to occur there. Increasing public concern about automobile safety has led to stricter laws, regulations and enforcement and technological innovations are being used in an effort to help reduce both the number and severity of traffic accidents. However, even with the aid of advanced safety features, the cause of most motor vehicle accidents is attributed to driver error related to driver inattention, perceptual errors, and decision errors.

### SUMMARY

The following presents a simplified summary of the disclosure in order to provide a basic understanding of aspects of the disclosure. This summary is not an extensive overview of the disclosure. It is not intended to identify key/critical elements of the disclosure or to delineate the scope of the disclosure. Its sole purpose is to present concepts of the disclosure in a simplified form as a prelude to the more detailed description that is presented later.

The disclosure presented and claimed herein includes a device, systems and methods for providing real-time safety information to a driver associated with the social and/or behavioral states of road users by detecting the presence of pedestrians and other road users in the vicinity of the vehicle, extracting attributes associated with the road users, calculating a state of the road user, correlating the calculated state with an indicator and communicating the indicator to the driver by spatially overlaying an augmented reality display on a volumetric heads up display within a visual field of the driver.

To the accomplishment of the foregoing and related ends, certain illustrative aspects of the disclosure are described herein in connection with the following description and the drawings. These aspects are indicative, however, of but a few of the various ways in which the principles of the disclosure can be employed and the subject disclosure is intended to include all such aspects and their equivalents. Other advantages and novel features of the disclosure will become apparent from the following detailed description of the disclosure when considered in conjunction with the drawings.

### BRIEF DESCRIPTION OF THE DRAWINGS

FIG. 1 illustrates a block diagram of a system for providing a driver with safety information using augmented reality in accordance with an aspect of the disclosure.

FIG. 2 illustrates an example flow chart of operations that facilitate for providing a driver with safety information using augmented reality in accordance with an aspect of the disclosure.

FIG. 3 illustrates an example system for providing a driver with safety information using augmented reality in accordance with an aspect of the disclosure.

FIG. 4 illustrates an example driver's view of an intersection in accordance with an aspect of the disclosure.

FIG. 5 illustrates example symbols of a system for providing a driver with safety information using augmented reality in accordance with an aspect of the disclosure.

FIG. 6 illustrates a block diagram of a computer operable to execute the disclosed architecture in accordance with an aspect of the disclosure.

FIG. 7 illustrates a block diagram of an example computing environment in accordance with an aspect of the disclosure.

FIG. 8 illustrates a block diagram of a device for providing a driver with safety information using augmented reality in accordance with an aspect of the disclosure.

### DETAILED DESCRIPTION

Generally described, the disclosure provides a driver with real-time behavioral and social state information of road users for increasing safety and reducing accidents. In an embodiment, this approach utilizes a volumetric Heads Up Display (HUD) to present a symbology system indicative of the social and behavioral states of pedestrians and other road users to a driver in real-time.

In accordance with an embodiment, the disclosure can include a volumetric or three-dimensional HUD, or video display showing a camera view with the symbology added as an overlay. It is important to the safety of road users that a system motivated by increasing driver awareness via engagement is extended to include HUDs. Deploying HUDs toward the purpose of saving lives by transforming the attention of drivers towards the primary task of driving. Three-dimensional augmented reality in the car can provide the driver with information in real-time greatly enhancing safety and positively transforming the relationship between drivers and others who share the roadways.

In an example aspect, yielding to pedestrians correctly is a behavior that not all drivers exhibit, therefore, many pedestrians are cautious even when they know they have right-of-way. As a safe practice, drivers should completely stop for the entire time pedestrians are in the crosswalk, and not drive through until they have fully crossed.

When a driver approaches an intersection there may a number of pedestrians nearby. The driver's attention may be focused on accomplishing multiple tasks, e.g. monitoring the traffic light, oncoming traffic and cross traffic. The driver has precious little time to assess each and every pedestrian when making decisions as to whether it is safe to proceed through the intersection, turn, slow down or stop. The disclosure provides a device, system and method for informing the driver in real-time of safety information related to the various states of road users in the vicinity of the vehicle so that the driver can make better, safer, faster, more informed driving decisions.

Indicators can be used to convey information associated with the social and behavioral states of road users in the vicinity of the vehicle. The indicators can include visual, audio and/or tactile notifications or alerts. In aspects the indicators can include a symbology system including a collection of visual symbols. The symbols may be displayed within the driver's line of sight using a volumetric HUD and can be positioned, for example, to appear in the display over the head of the pedestrians. The system can display a symbol associated with a pedestrian informing the driver that the pedestrian has made eye contact with the driver and has stopped moving. The system can display a different symbol for another pedestrian who is using an electronic device, or is otherwise distracted, and who has not made eye contact with the driver. The driver can use the information related to the pedestrians' status to aid in determining whether it is safe to proceed through the intersection.

In other aspects, the system and method can provide an indicator to the driver that a pedestrian is inattentive and unaware of the approaching vehicle and is likely to step out into the street without looking. Armed with this status and safety information, the driver can take precautions such as stopping, yielding, slowing down, waiting to turn or issuing a short horn blast to inform the pedestrian of the vehicle's presence.

In heavily populated areas such as an urban setting, at an outdoor event or college campus, large numbers of pedestrians may be present in groups. In an example aspect, the system and method can calculate the state of the pedestrians and present the calculated status of the pedestrians, in the form of an indicator, to the driver much more quickly and reliably than the driver is able to determine on his own. Providing a driver with real-time behavior and social state information of road users can increase safety and reduce accidents.

For the purposes of this disclosure, the term “road user” is intended to refer to any of a pedestrian, runner, driver, cyclist, motor vehicle, motor vehicle operator, animal, obstacle and most any other being or entity of interest capable of detection and for which safety information can be communicated to a driver.

For the purposes of this disclosure, the terms “behavioral state” and “social state” are intended to refer to any of a behavioral, social, physical or positional condition or status of a road user. A road user's state can include, for example, information associated with the road user's physical location, movement, motion, gestures, emotional state, attentiveness, visual axis, facial expression, facial or body orientation, and most any other information of interest.

As used in this application, the term “component” is intended to refer to a computer-related entity, either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

As used herein, the term to “infer” or “inference” refer generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

The disclosure is now described with reference to the drawings, wherein like reference numerals are used to refer to like elements throughout. In the following description, for purposes of explanation, numerous specific details are set forth in order to provide a thorough understanding of the subject disclosure. It may be evident, however, that the disclosure can be practiced without these specific details. In other instances, well-known structures and devices are shown in block diagram form in order to facilitate describing the disclosure.

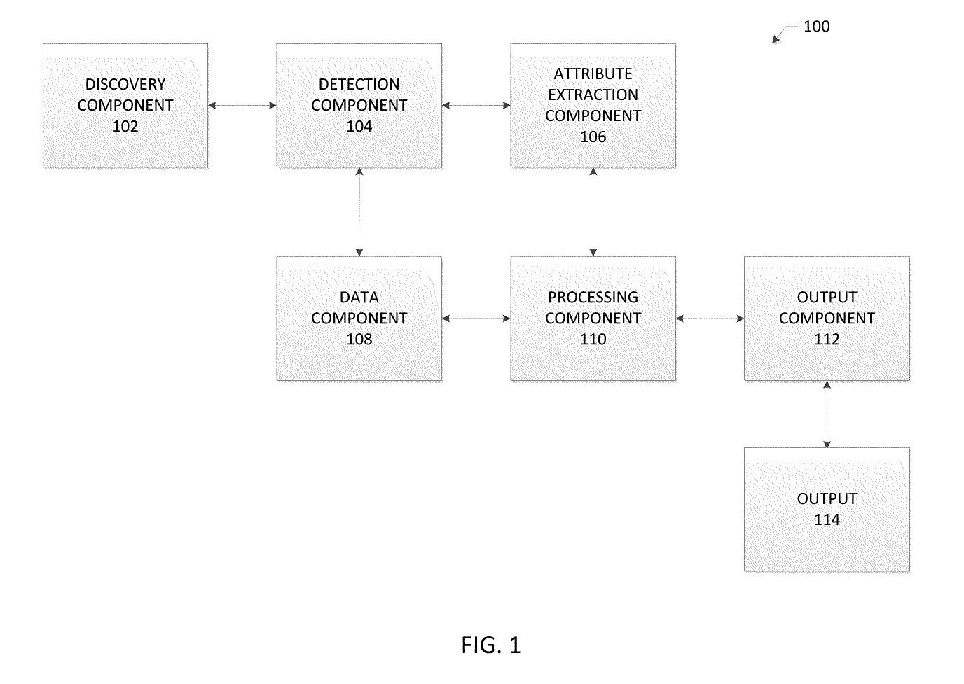

With reference to the drawings, FIG. 1 illustrates an example block diagram of an augmented reality system 100 that facilitates providing safety information to a vehicle driver. System 100 includes discovery component 102, detection component 104, attribute extraction component 106, data component 108, processing component 110, output component 112 and output 114. In an embodiment, system 100 can receive and process information associated with most any number of road users in the vicinity and provide an output containing safety information to a vehicle driver in real-time.

Discovery component 102 can include sensors (e.g., image sensors such as stereo cameras, depth cameras, charge-coupled devices, complementary metal oxide semiconductor active pixel sensors, infrared and/or thermal sensors, sensors associated with an image intensifier, and others) that receive at least one image, or other sensor data, capturing at least a portion of a road user, for example, a pedestrian. In one or more embodiments, discovery component 102 can be integrated into or with other components (e.g., 104, 106). An image, for example a record or frame, of a pedestrian, or portion thereof, can be provided to the detection component 104 for processing that facilitates the identification of a pedestrian's location and/or orientation.

Detection component 104 can detect the presence and location a road user, for example, a runner, driver, cyclist, motor vehicle, animal and most any other entity of interest. Road users within the driver's field of view can be detected and identified using known algorithms.

Attribute extraction component 106 can extract an attribute of a pedestrian identified by the detection component 104. Extracting the attributes of the pedestrian can include identifying data related to at least one of the social and/or behavioral state of the pedestrian including direction of the movement, gait, change in gait, facial expression, facial orientation, eye contact, gaze, visual axis, head pose, type, gestures, location or position relative to the vehicle, motion, direction of travel, speed, facial expression, line of sight, visual axis, body language, gestures, gait, change in gait, walking pattern, change in walking pattern and most any other information of interest. In an embodiment, the attribute extraction component 106 can use location data, facial recognition, facial expression recognition, gaze recognition, head pose estimation, gesture recognition and other techniques to extract attributes of a pedestrian.

In accordance with an embodiment, the data component 108 can include a database for storing a system of symbols, or other indicators, representative of various social or behavioral states of pedestrians and other road users within the vicinity of a vehicle.

Processing component 110 can receive attribute information associated with a pedestrian from attribute extraction component 106 for processing. Processing component 110 can also receive other forms and types of information from data component 108. Processing component 110 can include hardware and/or software capable of receiving and processing pedestrian attribute data, for example, hardware and/or software capable of determining various social or behavioral states of the pedestrian based on the extracted attributes and other information. Processing component 110 calculates a state or states of the pedestrian and can automatically correlate the attributes and/or calculated states of the road user with one or more indicators stored in data component 108.

Processing component 110 can utilize extracted attributes and other information to calculate whether the road user is aware, or is likely to be aware, of a traffic situation, has made eye contact with a vehicle, is stopped at a crosswalk or is inattentive, distracted or unaware of his immediate surroundings. In accordance with an embodiment, the facial orientation, visual axis and walking pattern of a pedestrian can be used to infer or predict a level of awareness of a pedestrian and likelihood that the pedestrian is cognizant of an approaching vehicle. In an aspect, processing component 110 applies a classification algorithm determined based on supervised machine learning to classify attributes and calculates the state or condition of the pedestrian.

Output component 112 is capable of receiving input from the processing component 110 and can provide an audio, visual or other output 114 for communicating an indicator in response. For example, the output component 112 can provide an output, or outputs, 114 including spatially overlaying an augmented reality display on a volumetric heads up display within a visual field of the driver. In an embodiment, the output component 112 can provide an output 114 displaying a symbol within the driver's line of sight proximate to an associated pedestrian or other road user. In an embodiment, output component 112 can provide an output 114 capable of being observed on, or for controlling, a heads-up display (HUD) within a vehicle, real-time video display or can be used to manage other controls and indicators (e.g., meters and gages below dash board, display associated with center console, navigation system, entertainment system, etc. . . . ). In an aspect, outputting an indicator to the driver includes outputting a visual, an audio indicator and/or a tactile indicator.

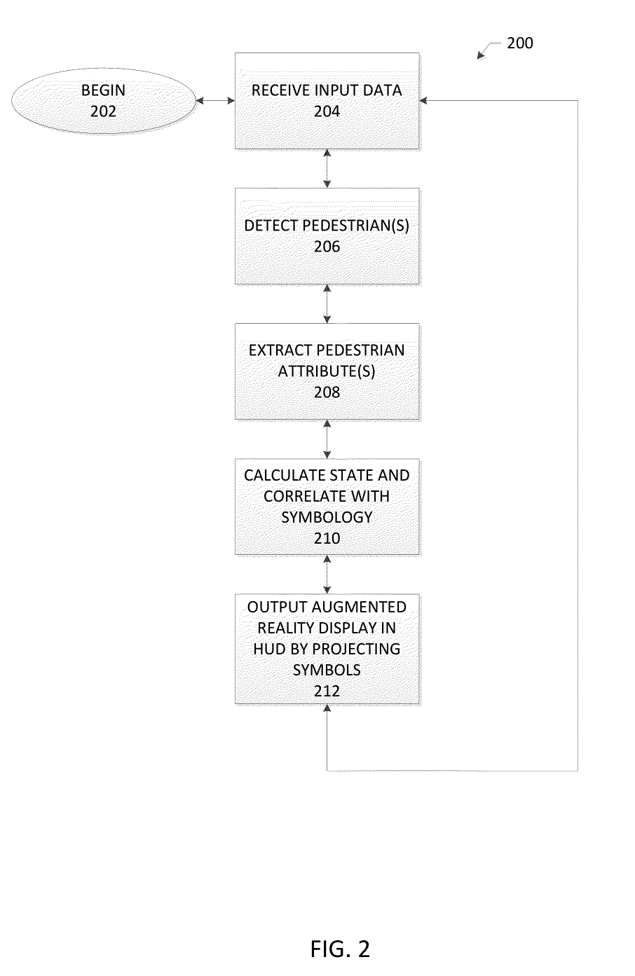

FIG. 2 illustrates a methodology of 200 in accordance with an aspect of the disclosure for providing safety information to a driver. At 202, methodology 200 is initiated, and proceeds to 204 where input data is received. Input data can include sensor data, for example, location data and one or more images or other data depicting pedestrians and/or other road users. A sensor, or capture means, for example a stereo or depth camera, can be employed to capture frames including at least a road user to be identified, located and/or tracked. In an embodiment, the sensors include a camera unit to produce image frames that have a region-of-interest (ROI) feature for automatically extracting data related to the facial regions of road users in the vicinity of the vehicle. The ROI feature can be used to capture data related to a region of interest spanning the face.

In further embodiments, sensor data can be obtained utilizing a time-of-flight camera, or range imaging camera system, that resolves distance based on the known speed of light, measuring the time-of-flight of a light signal between the camera and the subject for points of the image. In alternative or complementary embodiments, techniques involving reflective energy (e.g., sound waves or infrared beams) can be employed to detect the presence, position and other information related to road users, their motions, social states, behavioral states and predicted intentions.

Input data received at block 204 can include location and other data accessed from, from example, a car navigation system, smart phone, personal computing device, smart watch or most any other system or device having GPS (Global Positioning System) capabilities. In an aspect, input data received at block 204 can include data associated with a pedestrian obtained from a wearable computer with head mounted display (e.g. Google Glass), for example, head orientation, direction and speed of travel, and level of attentiveness.

At 206, a road user is detected, for example, a pedestrian and relevant data is identified based upon the input data received in block 204. In embodiments, a runner, driver, cyclist, motor vehicle, animal and most any other entity of interest can be detected. Once a road user is detected in an area near the vehicle, or within the driver's field of view, identification of attributes can begin. Road users can be identified using known algorithms.

In block 208, data associated with the detected road user can be utilized to extract attributes of the road user. Information related to the road user, for example, the road user's location or position relative to the vehicle's location, motion, direction of travel, speed, facial expression, facial orientation, line of sight, visual axis, body language, gestures, gait, change in gait, walking pattern, change in walking pattern and most any other information of interest, can be identified.

At block 210, the attributes extracted in block 208 are used to calculate a state of the road user. The calculated state can be automatically correlated with a symbol for display to the driver. A symbology system can include symbols indicative of various attributes of road users. Discrete symbols can be used to indicate the pedestrian's social or behavioral state, for example, whether the pedestrian has or has not made eye contact with the vehicle or driver. Symbols can be used to indicate that the pedestrian's state is, for example, ambiguous or unknown, purposeful, not paying attention, distracted, fatigued, tense, nervous, upset, sad, scared, panic-stricken, excited, alert, or relaxed. Symbols can be used to indicate motion or direction of travel of the road user, for example, stopped, moving forward, moving towards or away from the driver, moving to the left or right.

A symbol can indicate more than one attribute, for example, a single symbol may be used to indicate that the pedestrian has made eye contact with the driver, has stopped moving and it is safe for the vehicle to proceed. Other symbols may indicate a weighted combination of attributes. For example, when multiple attributes have been calculated for a pedestrian, more weight may be given to whether eye contact has been made rather than whether or not there has been a change in the pedestrian's gait, or vice versa. A weighted combination of attributes can be correlated to a symbol and the symbol can be presented to the driver. In an aspect, a symbol can include a zoomed in version of a pedestrian's face so that the driver can see the pedestrian's face in more detail and to give more saliency to the face of the pedestrian.

In block 212, an augmented reality display can be spatially overlaid on a heads up display, e.g., by projecting symbols indicative of the attributes or combination of attributes of road users within the driver's field of vision. The computer generated symbols can be superimposed over the real world view. Symbols can be displayed so as to appear proximate to the pedestrian in the driver's line of sight and sized so as to inform the driver without causing distraction. In an embodiment, a symbol can be displayed above or near the head of a pedestrian. The symbol can provide the driver with safety information concerning the pedestrian in real-time enabling the driver to assess the situation quickly.

According to one aspect of at least one version of the disclosure, the methodology 200 may include presenting a video image on a video display that reproduces the driver's field of view with symbols indicating various attributes, or combinations of attributes, of road users overlaid on the video image.

While for purposes of simplicity of explanation, the one or more methodologies shown herein, e.g., in the form of a flow chart, are shown and described as a series of acts, it is to be understood and appreciated that the subject disclosure is not limited by the order of acts, as acts may, in accordance with the disclosure, occur in a different order and/or concurrently with other acts from that shown and described herein. A methodology could alternatively be represented as a series of interrelated states or events, such as in a state diagram. Moreover, not all illustrated acts may be required to implement a methodology in accordance with the disclosure.

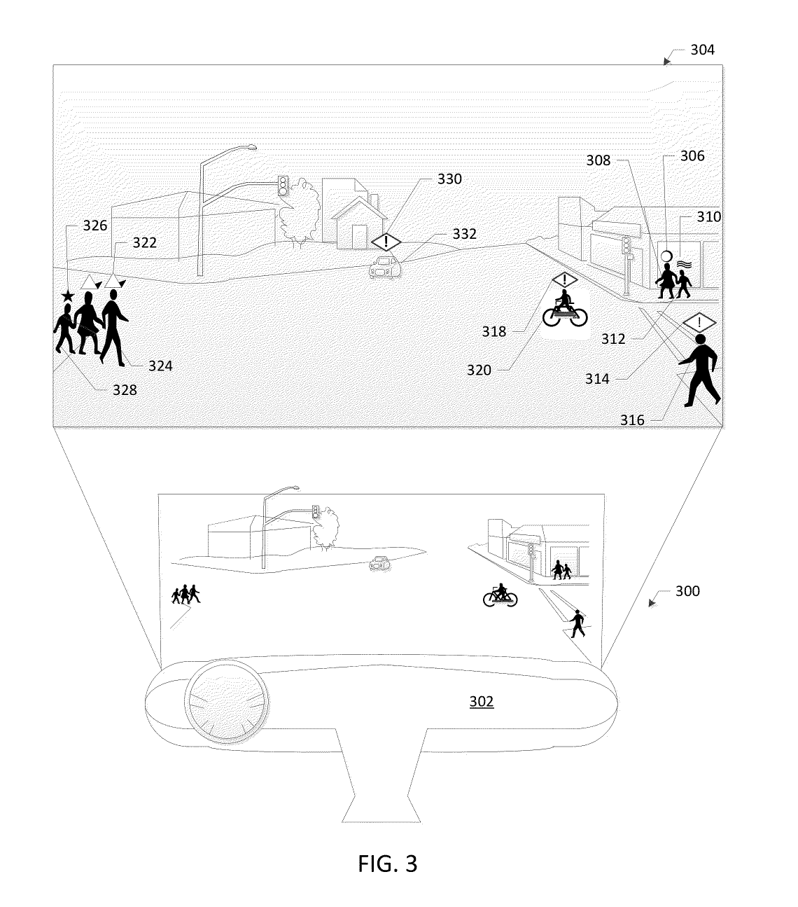

With reference to FIG. 3, an interior portion 300 of a vehicle 302 as viewed by the driver is depicted. An augmented reality system can provide real-time safety information regarding the social and/or behavioral states of road users to the driver of the vehicle 302. A volumetric heads up display (HUD) 304 is capable of projecting multiple focal planes with respect to a vantage point of the driver. The augmented reality system can map a forward view including pedestrians and other road users, and spatially overlay an augmented reality display on a volumetric heads up display 304 for a driver of the vehicle 302 by projecting symbols corresponding to social and/or behavioral states of the pedestrians. The heads up display 304 can create an augmented reality display of the unaltered front view as well as an overlaid view that appears to be at one or more focal planes.

With the availability of heads-up displays (HUDs) combined with augmented reality (AR), an augmented reality display can project visual information into the driver's field of view, creating the possibility for the driver's eyes to remain on the road while information is presented in the same three dimensional, visual world as the driving situation, as opposed to secondary displays.

An augmented reality display can spatially overlay symbol 306 on a volumetric heads up display 304. In this example, symbol 306 indicates the social and/or behavioral state of the pedestrian 308 directly beneath the symbol 306 as viewed by the driver of the vehicle 302. In an aspect, symbol 306 indicates that the pedestrian 308 has made eye contact with the vehicle and has stopped moving. Similarly, symbol 310 is presented to the driver and appears in the heads up display 304 above the pedestrian 312 as an indication of the social and/or behavioral state of the pedestrian 312. Symbol 310 indicates that the pedestrian 312 has made eye contact with the vehicle 302, has stopped moving and that the pedestrian 312 is likely a child. In an embodiment, symbols indicating the state of the pedestrian may appear in the heads up display 304 beneath, alongside, on top of, or nearby the associated pedestrian or other road user.

Symbol 314 indicates the social and/or behavioral state of the pedestrian 316 directly beneath the symbol 314 as viewed by the driver of the vehicle 302. In an aspect, symbol 314 indicates that the pedestrian 316 is distracted, has not made eye contact with the vehicle, has continued moving and may step into the path of the vehicle 302. Symbol 314 can be used to attract the driver's immediate attention so as to maximize the time available for the driver's response.

Symbol 318 indicates the social and/or behavioral state of the bicyclist 320 directly beneath the symbol 318 as viewed by the driver of the vehicle 302. In an aspect, symbol 314 indicates that the bicyclist 320 has not made eye contact with the vehicle, has continued moving and may move into the path of the vehicle 302.

Symbol 322 indicates the social and/or behavioral state of the pedestrian 324 directly beneath the symbol 322 as viewed by the driver of the vehicle 302. In an aspect, symbol 322 indicates that the pedestrian 308 has not made eye contact with the vehicle 302, is moving in a direction away from the vehicle and is at low risk for moving into the path of the vehicle 302. Similarly, symbol 326 is presented to the driver and appears in the heads up display 304 above the pedestrian 328 as an indication of the social and/or behavioral state of the pedestrian 328. Symbol 326 indicates that the pedestrian has not made eye contact with the vehicle 302, is moving in a direction away from the vehicle, is at low risk for moving into the path of the vehicle 302 and that the pedestrian 328 is likely a child.

Symbol 330 indicates the social and/or behavioral state of the driver of vehicle 332 directly beneath the symbol 330 as viewed by the driver of the vehicle 302. In an aspect, symbol 330 indicates that the driver of vehicle 332 has not made eye contact with the vehicle 302, has continued moving and may move into the path of the vehicle 302.

In an embodiment, the symbols (e.g. 306, 310, 314, 318, 322, 326, 330) can be automatically correlated by the system and method based on attributes and/or calculated states (e.g. social and/or behavioral states) of the associated road users. The symbols can be displayed in real-time providing valuable safety information to the driver. In an embodiment, the attributes, states, condition or status of road users can be re-calculated, correlated with an appropriate symbol and displayed to the driver in real-time or at a pre-determined rate. For example, the symbols can be updated once every second.

In an embodiment, the symbols can be color coded or include letters, words, and/or a motion component. Color can be used to convey information concerning the status of road users. In further embodiments, the symbols can be animated, for example a symbol may include an animated .gif spatially overlaid utilizing an augmented reality display on a volumetric heads up display. The motion of the symbol can be used to attract the driver's attention and to convey information concerning the status of a road user. The symbols can include most any other characteristics capable of conveying information.

In accordance with an embodiment, in addition to or in place of a symbol, the driver may be presented with an audio or tactile indication of the state of road users. For example, an audible warning may be presented to the driver when the system has calculated attributes that indicate that a road user is at high risk for entering the path of the vehicle. A tactile indication, e.g. haptic technology such as a force or vibration, may be used to convey the same or similar information to the driver.

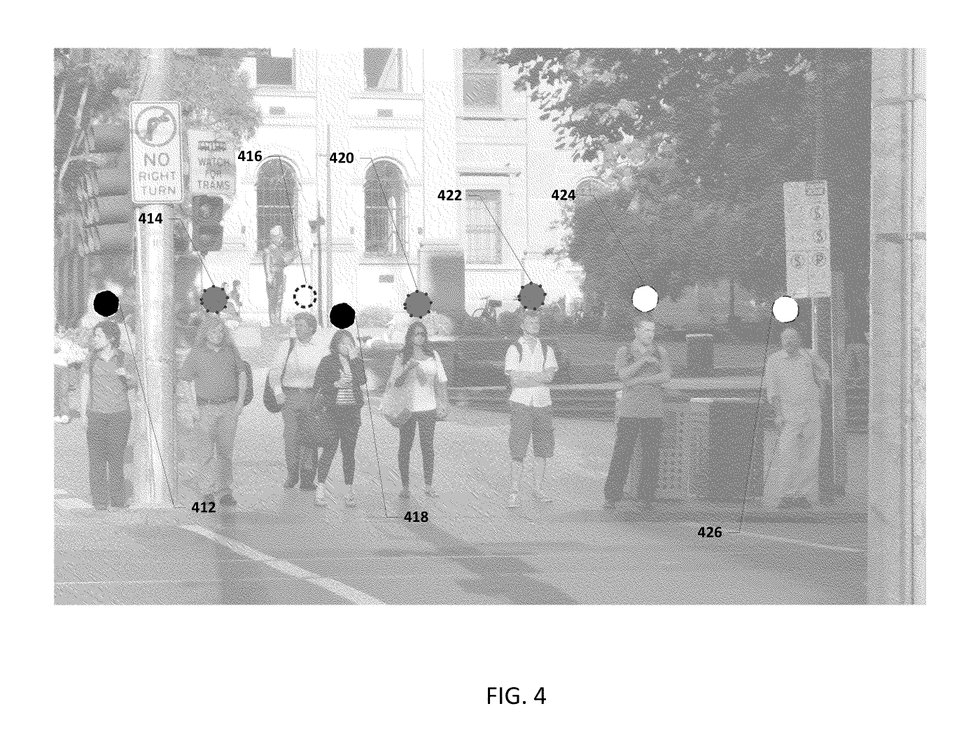

FIG. 4 depicts an example roadway intersection with a group of pedestrians on a street corner. The driver's view out the front windshield with the symbols 412-426 overlaid within the driver's field of view is shown. The symbols 412-426 are projected onto a HUD augmented reality and provide safety information to the driver. In this example embodiment, the symbols are positioned such that they appear above the head of the pedestrian. The symbols 414, 420, 422 indicate that the pedestrians have made eye contact with the driver or vehicle and are stationary or have stopped walking. Given this information the driver may discern that the pedestrians are aware of the vehicle's approach and are unlikely to step into the path of the vehicle. Symbols 416, 424 and 426 can be used to indicate that the pedestrians have not made eye contact with the vehicle, or are otherwise distracted, and the driver is alerted that the pedestrians are at risk of entering the intersection.

In an aspect, symbols 412 and 418 are used to indicate that the designated pedestrians are inattentive and moving towards the intersection and, thus, are at very high risk of entering into the intersection or into the path of the vehicle. Armed with this real-time information, the driver can conform his immediate driving habits to the present conditions and focus his attention where problems are more likely to occur, e.g. on pedestrians that have been indicated as not having noticed the vehicle. Because the driver has been informed as to the social and or behavioral states of road users within the vicinity of the vehicle, the driver can include this information in his decision making process and take preventative actions or precautions such as slowing down, yielding the right of way, warning the pedestrian using the car horn, or stopping. The driver is provided with the safety information in real-time enabling the driver to prevent or lessen the impact of potential accidents.

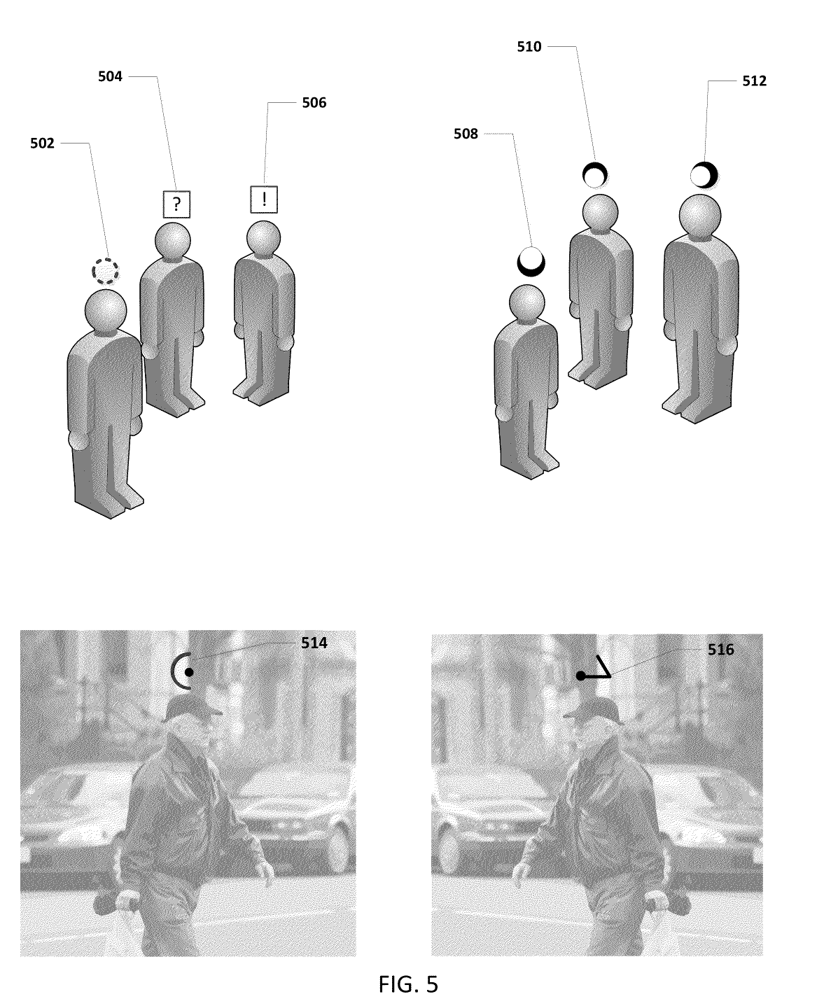

Referring now to FIG. 5, there is illustrated example symbols displayed associated with a particular pedestrian. In an example symbology system, symbol 502 can be used to indicate that the pedestrian has made eye contact with the car and has stopped moving therefore there is low probability that the pedestrian will move within the path of the vehicle. Symbol 504 can be used to indicate that the social and/or behavioral state of the pedestrian is undetermined. Symbol 506 can be used to indicate that the pedestrian is distracted, distraught, has not made eye contact, and/or has continued moving toward the roadway, therefore, there is a high probability that the pedestrian will move within the path of the vehicle.

In other example symbology systems, symbol 508 can be used to indicate that the pedestrian has made eye contact with the car and has stopped moving therefore there is low probability that the pedestrian will move within the path of the vehicle. Symbol 510 can be used to indicate that the social and/or behavioral state of the pedestrian is undetermined. Symbol 512 can be used to indicate that the pedestrian is distracted, distraught, has not made eye contact, and/or has continued moving toward the intersection, therefore, there is a high probability that the pedestrian will move within the path of the vehicle.

In another example symbology system, symbol 514 can be used to indicate that the pedestrian has made eye contact with the vehicle and is proceeding into the path of the vehicle. Symbol 516 can be used to indicate that the pedestrian has not made eye contact with the vehicle and is proceeding into the path of the vehicle. The driver can use the information conveyed by the symbols to assist in making safer driving decisions.

In an embodiment, the symbology can optionally be customized by the user to provide more or less details of the pedestrian's state by utilizing an increased symbol set or reduced symbol set respectively. In an embodiment, the complexity and number of symbols used can be increased over time as the driver becomes accustomed to the symbology system. In an embodiment, the graphic symbol system can be built up slowly so that the user can learn the symbols in a phased approach. For example, in the initial stage, a driver may be presented with a reduced set of basic symbols which are used to convey basic information concerning the state of identified road users. Over time, the number of symbols can be increased to reflect additional details, social and behavioral states as the driver becomes familiar with the symbology system. The symbology system can be user selectable, for example, the driver can select the level of detail displayed by the system choosing more or less detail. The system can be programmed to automatically provide more detail when driving conditions are poor (e.g. darkness, fog, rain . . . ), when the driver is in an unfamiliar geographic area or upon request.

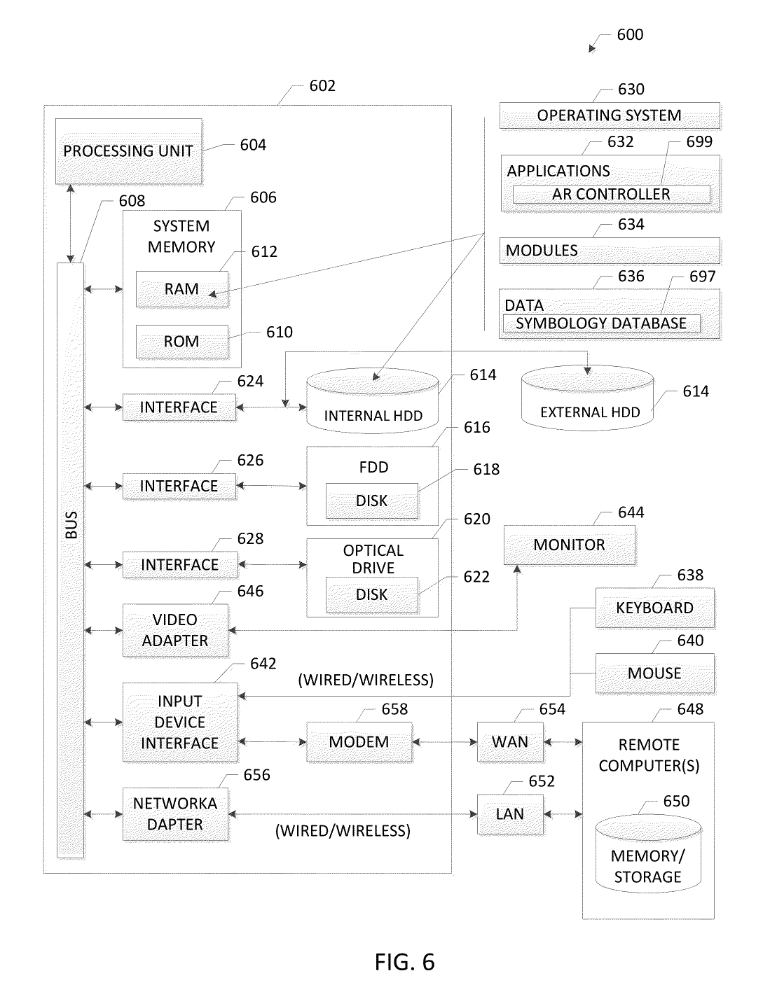

In order to provide additional context for various aspects of the subject disclosure, FIG. 6 and the following discussion are intended to provide a brief, general description of a suitable computing environment 600 in which the various aspects of the disclosure can be implemented. While the disclosure has been described above in the general context of computer-executable instructions that may run on one or more computers, those skilled in the art will recognize that the disclosure also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the disclosure may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer-readable media can include computer storage media and communication media. Computer storage media may include volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CDROM, digital versatile disk (DVD) or other optical disk storage, or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

With reference again to FIG. 6, the example environment 600 for implementing various aspects of the disclosure includes a computer 602, the computer 602 including a processing unit 604, a system memory 606 and a system bus 608. The system bus 608 couples system components including, but not limited to, the system memory 606 to the processing unit 604. The processing unit 604 can be any of various commercially available processors. Dual microprocessors and other multiprocessor architectures may also be employed as the processing unit 604.

The system bus 608 can be any of several types of bus structure that may further interconnect to a memory bus (with or without a memory controller), a peripheral bus, and a local bus using any of a variety of commercially available bus architectures. The system memory 606 includes read-only memory (ROM) 610 and random access memory (RAM) 612. A basic input/output system (BIOS) is stored in a non-volatile memory 610 such as ROM, EPROM, EEPROM, which BIOS contains the basic routines that help to transfer information between elements within the computer 602, such as during start-up. The RAM 612 can also include a high-speed RAM such as static RAM for caching data.

The computer 602 further includes an internal solid state drive (SSD) or hard disk drive (HDD) 614 (e.g., EIDE, SATA) which may also be configured for external use in a suitable chassis (not shown), a magnetic floppy disk drive (FDD) 616, (e.g., to read from or write to a removable diskette 618) and an optical disk drive 620, (e.g., reading a CD-ROM disk 622 or, to read from or write to other high capacity optical media such as the DVD). The hard disk drive 614, magnetic disk drive 616 and optical disk drive 620 can be connected to the system bus 608 by a hard disk drive interface 624, a magnetic disk drive interface 626 and an optical drive interface 628, respectively. The interface 624 for external drive implementations includes at least one or both of Universal Serial Bus (USB) and IEEE 1394 interface technologies. Other external drive connection technologies are within contemplation of the subject disclosure.

The drives and their associated computer-readable media provide nonvolatile storage of data, data structures, computer-executable instructions, and so forth. For the computer 602, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the example operating environment, and further, that any such media may contain computer-executable instructions for performing the methods of the disclosure.

A number of program modules can be stored in the drives and RAM 612, including an operating system 630, one or more application programs 632, other program modules 634 and program data 636. All or portions of the operating system, applications, modules, and/or data can also be cached in the RAM 612. It is appreciated that the disclosure can be implemented with various commercially available operating systems or combinations of operating systems.

A user can enter commands and information into the computer 602 through one or more wired/wireless input devices, e.g., a keyboard 638 and a pointing device, such as a mouse 640. Other input devices (not shown) may include a microphone, an IR remote control, a joystick, a game pad, a stylus pen, touch screen, or the like. These and other input devices are often connected to the processing unit 604 through an input device interface 642 that is coupled to the system bus 608, but can be connected by other interfaces, such as a parallel port, an IEEE 1394 serial port, a game port, a USB port, an IR interface, etc.

A monitor 644 or other type of display device is also connected to the system bus 608 via an interface, such as a video adapter 646. In addition to the monitor 644, a computer typically includes other peripheral output devices (not shown), such as speakers, printers, etc.

The computer 602 may operate in a networked environment using logical connections via wired and/or wireless communications to one or more remote computers, such as a remote computer(s) 648. The remote computer(s) 648 can be a workstation, a server computer, a router, a personal computer, portable computer, microprocessor-based entertainment appliance, a peer device or other common network node, and typically includes many or all of the elements described relative to the computer 602, although, for purposes of brevity, only a memory/storage device 650 is illustrated. The logical connections depicted include wired/wireless connectivity to a local area network (LAN) 652 and/or larger networks, e.g., a wide area network (WAN) 654. Such LAN and WAN networking environments are commonplace in offices and companies, and facilitate enterprise-wide computer networks, such as intranets, all of which may connect to a global communications network, e.g., the Internet.

When used in a LAN networking environment, the computer 602 is connected to the local network 652 (within the vehicle 304 (FIG. 3) through a wired and/or wireless communication network interface or adapter 656. The adapter 656 may facilitate wired or wireless communication to the LAN 652, which may also include a wireless access point disposed thereon for communicating with the wireless adapter 656.

When used in a WAN networking environment, the computer 602 can include a modem 658, or is connected to a communications server on the WAN 654, or has other means for establishing communications over the WAN 654, such as by way of the Internet. The modem 658, which can be internal or external and a wired or wireless device, is connected to the system bus 608 via the serial port interface 642. In a networked environment, program modules depicted relative to the computer 602, or portions thereof, can be stored in the remote memory/storage device 650. It will be appreciated that the network connections shown are example and other means of establishing a communications link between the computers can be used.

The computer 602 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi allows connection to the Internet without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11(a, b, g, n, etc.) to provide secure, reliable, fast wireless connectivity. A Wi-Fi network can be used to connect computers and devices to each other, to the Internet, and to wired networks (which use IEEE 802.3 or Ethernet). Wi-Fi networks operate in the unlicensed 2.4 and 5 GHz radio bands, at an 11 Mbps (802.11b) or 54 Mbps (802.11a) data rate, for example, or with products that contain both bands (dual band), so the networks can provide real-world performance similar to the wired Ethernet networks used in many offices.

The program data 636 may include a symbology database 697, or other software applications, for storing symbols, .gif files, audio files, and most any other indicators for use by the system. The applications 632 may include an AR controller application 699 that performs certain augmented reality operations as described herein.

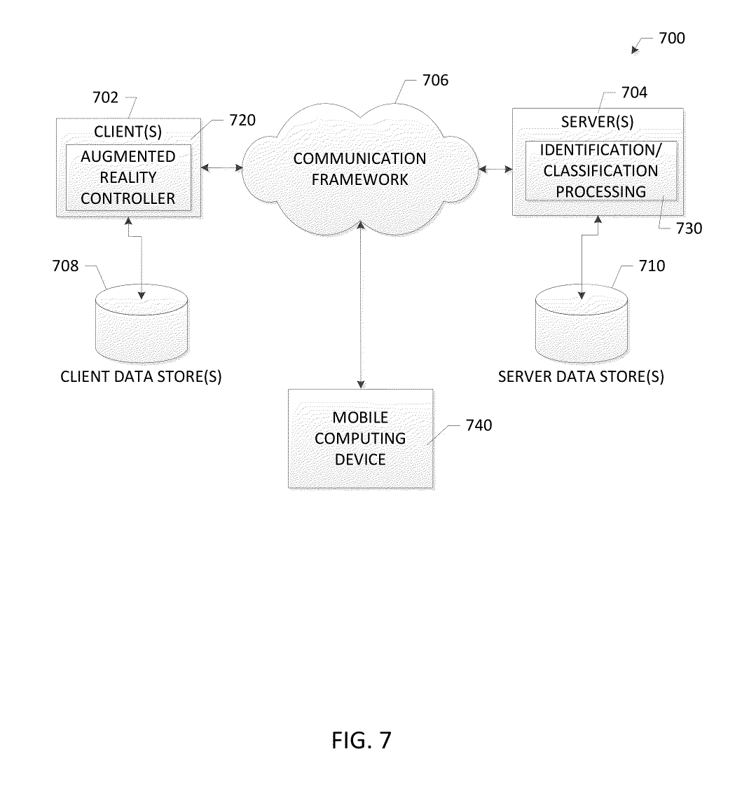

Referring now to FIG. 7, there is illustrated a schematic block diagram of an example computing environment 700 in accordance with the subject disclosure. The system 700 includes one or more client(s) 702. The client(s) 702 can be hardware and/or software (e.g., threads, processes, computing devices). The client(s) 702 can house cookie(s) and/or associated contextual information by employing the disclosure, for example.

The system 700 may include one or more server(s) 704. The server(s) 704 can also be hardware and/or software (e.g., threads, processes, computing devices). The servers 704 can house threads to perform transformations by employing the disclosure, for example. One possible communication between a client 702 and a server 704 can be in the form of a data packet adapted to be transmitted between two or more computer processes. The data packet may include a cookie and/or associated contextual information, for example. The system 700 includes a communication framework 706 (e.g., a global communication network such as the Internet) that can be employed to facilitate communications between the client(s) 702 and the server(s) 704.

Communications can be facilitated via a wired (including optical fiber) and/or wireless technology. The client(s) 702 are operatively connected to one or more client data store(s) 708 that can be employed to store information local to the client(s) 702 (e.g., cookie(s) and/or associated contextual information). Similarly, the server(s) 704 are operatively connected to one or more server data store(s) 710 that can be employed to store information local to the servers 704.

For example, the client(s) 702 may locally host an augmented reality controller 720 that performs certain operations described herein that cooperates with an identification and classification processor 730 that is hosted on server(s) 704 that performs certain other operations described herein.

In accordance with other embodiments (not shown), the computing environment 700 may be self-contained and local to the vehicle and does not include a connection to a remote server or remote data stores. In an aspect, the computing environment 700 including client(s) 702, server(s) 704, communication framework 706, client data store(s) 708, server data store(s) 710, augmented reality controller 720 and identification and classification processor 730 is local to a vehicle and does not include a connection to a global communication network such as the Internet.

In further embodiments, the computing environment may include a stand-alone or adhoc network including a local computing environment 700, and mobile computing devices 740, for example, smart phone, tablet, head mounted device, e.g. Google Glass, or most any other mobile computing device.

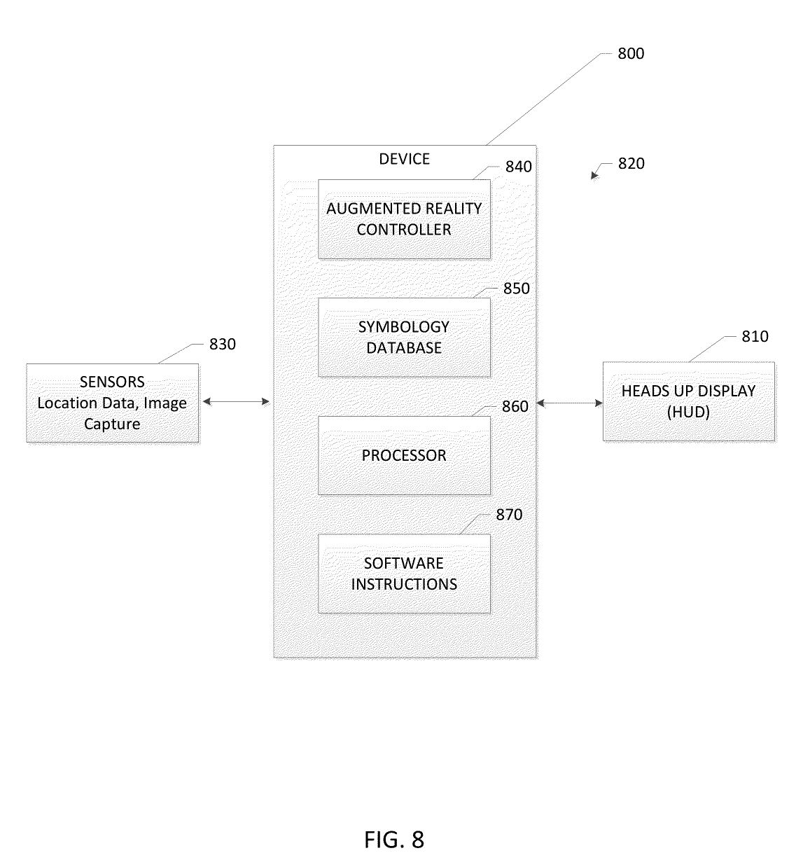

FIG. 8 illustrates a device 800 for providing a vehicle driver with safety information. The device 800 is in communication with a heads up display (HUD) 810 of an augmented reality driver system 820 and sensors 830. An augmented reality controller 840 (“controller”) is in communication with at least one symbology database 850 and has at least one processor 860 that executes software instructions 870 to perform operations of:

receiving sensor data associated with at least one road user;
detecting at least one road user in the sensor data;
extracting at least one attribute associated with the detected road user from the sensor data;
calculating a state of the road user based on the at least one extracted attribute;
automatically correlating the calculated states with one or more indicators; and
outputting the indicator to the driver.

In accordance with an embodiment, the controller 840 can cause the HUD 810 to project a system of symbols, or other indicators, representative of various social or behavioral states of pedestrians and other road users within a driver's line of sight. In an aspect, the HUD 810 can include most any output or display type, for example, video on an LCD or OLED display or digital cluster. The controller 840 can detect a pedestrian within the vicinity of the vehicle, calculate a state associated with the pedestrian, and cause the volumetric HUD 810 to overlay the augmented reality display with a an indicator of the pedestrian's calculated state.

In one illustrative version of the disclosure, the controller 840 can perform the operations of accessing a location of the vehicle, or a current trajectory of the vehicle, and can receive image capture data from the sensors 830. The controller 840 can extract an attribute of an identified pedestrian. A symbology database 850 stores symbols, or other indicators, and combinations of symbols that can be associated with the various attributes of pedestrians and other road users.

In one illustrative version of the disclosure, the software instructions 870 include classification algorithms for use by the controller 840 and processor 860 in calculating attributes and a state associated with a pedestrian or other road user. The controller 840 can perform operations that include correlating the calculated state with a symbol or symbols stored in the symbology database 850. In aspects, such a correlation can be accomplished automatically based on a set of predetermined rules.

Certain components that perform operations described herein may employ an artificial intelligence (AI) component which facilitates automating one or more features in accordance with the subject disclosure. A classifier is a function that maps an input attribute vector, x=(x₁, x₂, x₃, x₄, xₙ), to a confidence that the input belongs to a class, that is, f(x)=confidence(class). Such classification can employ a probabilistic and/or statistical-based analysis (e.g., factoring into the analysis utilities and costs) to prognose or infer an action that a user desires to be automatically performed.

A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

In an embodiment, the state associated with a road user may be calculated with a classification algorithm that is determined based on supervised machine learning. The supervised machine learning can be applied, for example, using a support vector machine (SVM) or other artificial neural network techniques. Supervised machine learning can be implemented to generate a classification boundary during a learning phase based on values of one or more attributes of one or more road users known to be indicative of, for example, the social or behavioral state of a road user.

As will be readily appreciated from the subject specification, the subject disclosure can employ classifiers that are explicitly trained (e.g., via a generic training data) as well as implicitly trained (e.g., via observing user behavior, receiving extrinsic information). For example, SVM's are configured via a learning or training phase within a classifier constructor and feature selection module. Thus, the classifier(s) can be used to automatically learn and perform a number of functions, including but not limited to determining according to a predetermined criteria.

What has been described above includes examples of the disclosure. It is, of course, not possible to describe every conceivable combination of components or methodologies for purposes of describing the subject disclosure, but one of ordinary skill in the art may recognize that many further combinations and permutations of the disclosure are possible. Accordingly, the disclosure is intended to embrace all such alterations, modifications and variations that fall within the spirit and scope of the appended claims. To the extent that the term “includes” is used in either the detailed description or the claims, such term is intended to be inclusive in a manner similar to the term “comprising” as “comprising” is interpreted when employed as a transitional word in a claim. Furthermore, the term “or” as used in either the detailed description or the claims is meant to be a “non-exclusive or”.

1. A computer implemented method for providing safety information to a driver, comprising:
utilizing one or more processors and memory storing one or more programs for execution by the one or more processors, the one or more programs including instructions for:
receiving sensor data associated with at least one road user;
detecting at least one road user in the sensor data;
extracting at least one attribute associated with the detected road user from the sensor data;
calculating a state of the road user based on the at least one extracted attribute;
correlating the calculated state with one or more indicators; and
providing the indicator to the driver.

2. The method for providing safety information to a driver of claim 1, wherein receiving sensor data associated with at least one road user comprises receiving location data, an infrared image, depth camera image or time-of flight sensor data.

3. The method for providing safety information to a driver of claim 1, wherein detecting at least one road user comprises identifying a pedestrian, cyclist, motor vehicle, animal or obstacle.

4. The method for providing safety information to a driver of 1, wherein providing the indicator to the driver comprises spatially overlaying an augmented reality display on a volumetric heads up display.

5. The method providing safety information to a driver of claim 1, wherein providing the indicator to the driver comprises displaying the indicator in a real-time video display.

6. The method for providing safety information to a driver of claim 1, wherein extracting at least one attribute comprises identifying data related to a direction of movement, gait, change in gait, facial expression, facial orientation, eye contact, gaze direction, body language, head pose, visual axis, type, gestures or location of the road user; and calculating a state of the road user comprises inferring at least one of the road user's emotional, behavioral, positional, physical or social state.

7. The method for providing safety information to a driver of claim 1, wherein calculating a state of the road user comprises applying a classification algorithm determined based on supervised machine learning to classify attributes of at least one road user.

8. The method for providing safety information to a driver of claim 1, wherein providing the indicator to the driver comprises displaying the symbol within the driver's line of sight.

9. The method of for providing safety information to a driver of claim 8, comprising displaying an animated symbol.

10. The method of providing safety information to a driver of claim 1, wherein providing the indicator comprises presenting a visual indicator and an audio indicator or a tactile indicator.

11. An augmented reality system for providing safety information to a driver, comprising:
an input component that receives data associated with a road user;
a detection component that detects at least one road user in the received data;
an extraction component that extracts at least one attribute associated with the detected road user;
a data component that stores indicators;
a processing component that calculates a state of the road user and correlates the at least one attribute of the road user with one or more of the stored indicators; and
an output component that communicates the indicator to the driver.

12. The augmented reality system for providing safety information to a driver of claim 11, wherein data associated with the road user comprises location data, an infrared image, depth camera image or time-of flight sensor data.

13. The augmented reality system for providing safety information to a driver of claim 11, wherein the road user comprises a pedestrian, cyclist, motor vehicle, animal or obstacle.

14. The augmented reality system for providing safety information to a driver of claim 11, wherein the processing component applies a classification algorithm determined based on supervised machine learning to classify the at least one attribute of the road user.

15. The augmented reality system for providing safety information to a driver of claim 11, wherein the output component comprises an augmented reality display and volumetric heads up display or a real-time video display.

16. The augmented reality system for providing safety information to a driver of claim 11, wherein the indicator comprises a virtual object or a virtual image and the output component projects the indicator in a visual field of the driver.

17. The augmented reality system for providing safety information to a driver of claim 11, wherein the at least one attribute comprises data related to a behavioral state, social state, location, orientation, motion, speed, direction of movement, gait, change in gait, facial expression, facial orientation, eye contact, visual axis, type or gestures of the road user.

18. The augmented reality system for providing safety information to a driver of claim 11, wherein the indicator comprises an image, text, video, audio or tactile indicator.

19. A device for providing safety information to a driver, comprising
a volumetric heads up display; and
a controller in communication with the volumetric heads up display, wherein the controller comprises at least one processor that executes software instructions to perform operations comprising:
receiving sensor data associated with at least one road user;
detecting at least one road user in the sensor data;
extracting at least one attribute associated with the detected road user from the sensor data;
calculating a state of the road user and correlating the calculated state with one or more indicators; and
spatially overlaying an augmented reality display on a volumetric heads up display by projecting the indicator in a visual field of the driver.

20. The device of claim 20, wherein the at least one attribute comprises data related to a behavioral state, social state, location, orientation, motion, speed, direction of movement, gait, change in gait, facial expression, facial orientation, eye contact, visual axis, type or gestures of the road user and the indicator comprises an image, text or symbol.
